(19) United States
(12) Patent Application Publication
(10) Pub. No.: US 2019/0122570 A1
(43) Pub. Date: Apr. 25, 2019

(54) METHOD FOR DETERMINING ENDPOINT(S) FOR DECIDING TO TRIGGER EVASIVE MANEUVER BY AN AIRCRAFT, ASSOCIATED DEVICE AND COMPUTER PROGRAM

(71) Applicant: THALES, Courbevoie (FR)

(72) Inventors: Laurent Flotte, Toulouse (FR); Ronan Demoment, Toulouse (FR); Stéphane Fleury, Toulouse (FR)

(21) Appl. No.: 16/165,882

(22) Filed: Oct. 19, 2018

(30) Foreign Application Priority Data
Oct. 20, 2017 (FR) 1701091

(51) Int. Cl. G08G 5/04; G05B 15/02; G08G 5/00

(52) U.S. Cl. CPC G08G 5/045; G08G 5/0013; G08G 5/0039; G05B 15/02

(57) ABSTRACT

A method for determining endpoint(s) for deciding to trigger evasive maneuver by an aircraft, an associated device and computer program are disclosed. In one aspect, the method includes obtaining an anticipated route of the aircraft and a set of locations on the route presenting a collision risk for the aircraft, determining, for each location of the set, an endpoint for deciding to trigger an evasive maneuver associated with the location, by applying a rule for determining an endpoint associated with the location, and segmenting the route into a set of N route segments, with N≥2. The rule for determining the endpoint associated with the location of the set is a function of the route segment in which the location associated with the set is located.

### CROSS-REFERENCE TO RELATED APPLICATIONS

This patent application claims the benefit under 35 U.S.C. § 119 of French Application No. FR 17 01091 filed on Oct. 20, 2017, which is hereby incorporated by reference in its entirety.

### BACKGROUND

### Technological Field

The described technology relates to the field of aircraft, with or without an on-board pilot, such as drones. Most modern aircraft are now equipped with automatic pilot coupled with a mission management device of the Flight Management System (FMS) type: the FMS for example provides a flight plan and the automatic pilot slaves the aircraft so that it follows said flight plan. It may also be used alone for example to make changes in heading or altitude. In this last scenario, the itinerary followed therefore differs from the anticipated flight plan. These changes are often made with the aim of optimizing the flight plan after an authorization from the ground tracking station or to rejoin a flight plan more quickly or for an approach procedure.

### Description of the Related Technology

A provisional route calculated for an aircraft, which may be a flight plan or an itinerary, may, depending on the case, have been developed initially on the ground or in an aircraft, then undergo changes during flight. Once the route is developed, it must be secured. The securing of a provisional route seeks to guarantee, inter alia, that on the one hand the route does not collide with elements presenting a potential safety threat for the flight of the aircraft, such as reliefs or fixed obstacles, a dangerous deteriorated weather situation, other anticipated traffic (air traffic or the like), and that on the other hand, the anticipated itinerary does not encounter other potentially threatening elements regarding the proper performance of the mission, for example that it does not use prohibited or risky flyovers zones (towns that it is prohibited to fly over, war or military zones, periodic events such as fireworks, etc.), some of these zones thus being able to be stamped “prohibited” or “risky” only on certain days and/or at certain times. A securing device thus identifies a list of potential threats on the route, which must be reported to the crew and/or the onboard systems through alerts, and for each threat, it determines a decision endpoint to trigger a threat avoidance procedure if applicable.

### SUMMARY OF CERTAIN INVENTIVE ASPECTS

In one aspect, the described technology relates to a method for determining endpoint(s) for deciding to trigger an evasive maneuver by an aircraft, comprising the following steps implemented by computer: obtaining an anticipated route of the aircraft and a set of location(s) on said route presenting a collision risk for the aircraft; determining, for each location of said set, an endpoint for deciding to trigger an evasive maneuver associated with said location of said set, by applying a rule.

Furthermore, among the systems on board an aircraft, whether or not it is piloted by an on-board human pilot, some are responsible for monitoring the short-term itinerary, for example the Terrain Awareness and Warning System (TAWS), or over the longer term. In case of incoherence between the alerts of the securing device and those of such onboard systems, the pilot of the aircraft, whether he is on board or on the ground in the case of a drone, must determine whether there is actually a threat. This type of incoherence naturally leads to doubting the efficacy of the two systems and also leads to a non-negligible workload.

It is therefore important in some embodiments to improve the coherence between the device for securing the route of the aircraft and the on-board monitoring systems, while limiting the computing load as much as possible relative to the securing of the route.

To that end, according to a first inventive aspect, the described technology includes a method for determining endpoint(s) for deciding to trigger an evasive maneuver by an aircraft, of the aforementioned type, characterized in that it further comprises a step for segmenting the route into a set of N route segments, with N≥2 and in that the rule for determining an endpoint associated with a location of said set is a function of the route segment in which the location associated with said set is located.

The described technology thus makes it possible to limit the computing load of the endpoints for deciding to trigger an evasive maneuver, by adapting the processing precision as a function of the distance, and therefore limiting the necessary computing resources. The reactivity of the system is thereby improved. Indeed, the further away the threat is from the aircraft, the rougher one can be regarding the location of the avoidance point. Conversely, the closer it is, the more relevant one must be with the goal of optimizing the performance of the mission while remaining close to what was initially anticipated.

The described technology further makes it possible to improve the coherence between the device for securing the route of the aircraft and the on-board monitoring systems, and thus participates in increasing the mastery of securing of the route. The different considered configurations in particular make it possible to adapt to the on-board monitoring solution, whatever it may be.

The described technology is further easily adaptable to any type of mission associated with a variety of types of aircraft.

In embodiments, the method according to the described technology further includes one or more of the following features:

the rule for determining an endpoint associated with a location of said set that is located in a first segment of said set of segments comprises the application, relative to said location, of a first predefined vertical profile, and the rule for determining an endpoint associated with a location of said set that is located in a second segment of said set of segments and different from the first segment comprises the application, relative to said location of said set, of a second predefined vertical profile different from the first vertical profile;

a first segment of the set of segments extends from the current position of the aircraft and up to at least the furthest point from the aircraft on the anticipated route that is located in the detection field of an on-board monitoring device during flight proposing anti-collision maneuvers;

the first vertical profile corresponds to a vertical profile of the TAWS evasive maneuver type;

the second segment extends from the end of the first segment distant from the aircraft, and the second vertical profile comprises a first line segment along the route and a second line segment corresponding to a gradient greater than that of the first line segment;

a third segment of the set of segments extends from the end of the second segment distant from the first segment, and the rule for determining an endpoint associated with a location of said set that is located in a third segment comprises the application, relative to said point of said set, of a third profile corresponding to a single line segment with a gradient calculated as a function of the gradient of the anticipated route on the third segment.

According to a second aspect, the described technology includes a computer program including software instructions which, when executed by a computer, carry out a method as defined above.

According to a third aspect, the described technology includes a device for determining endpoint(s) for deciding to trigger an evasive maneuver by an aircraft, comprising: a first unit suitable for obtaining an anticipated route of the aircraft and a set of location(s) on said route presenting a collision risk for the aircraft; a second unit suitable for determining, for each location of said set, an endpoint for deciding to trigger an evasive maneuver associated with said location, by applying a rule; said device being characterized in that it is suitable for segmenting the route into a set of N route segments, with N≥2 and in that the rule for determining an endpoint associated with a location of said set is a function of the route segment in which the location associated with said set is located.

### BRIEF DESCRIPTION OF THE DRAWINGS

These features and advantages of the described technology will appear upon reading the following description, provided solely as an example, and done in reference to the appended drawings, in which:

FIG. 1 shows a view of a conflict detection device implementing one embodiment of the described technology;

FIG. 2 is a flowchart of steps implemented in one embodiment of the described technology;

FIG. 3 illustrates, in the horizontal plane, the determination of endpoint(s) for deciding to trigger an evasive maneuver by an aircraft in one embodiment of the described technology;

FIG. 4 illustrates, in the vertical plane, the determination of endpoint(s) for deciding to trigger an evasive maneuver by an aircraft in one embodiment of the described technology.

### DETAILED DESCRIPTION OF CERTAIN INVENTIVE EMBODIMENTS

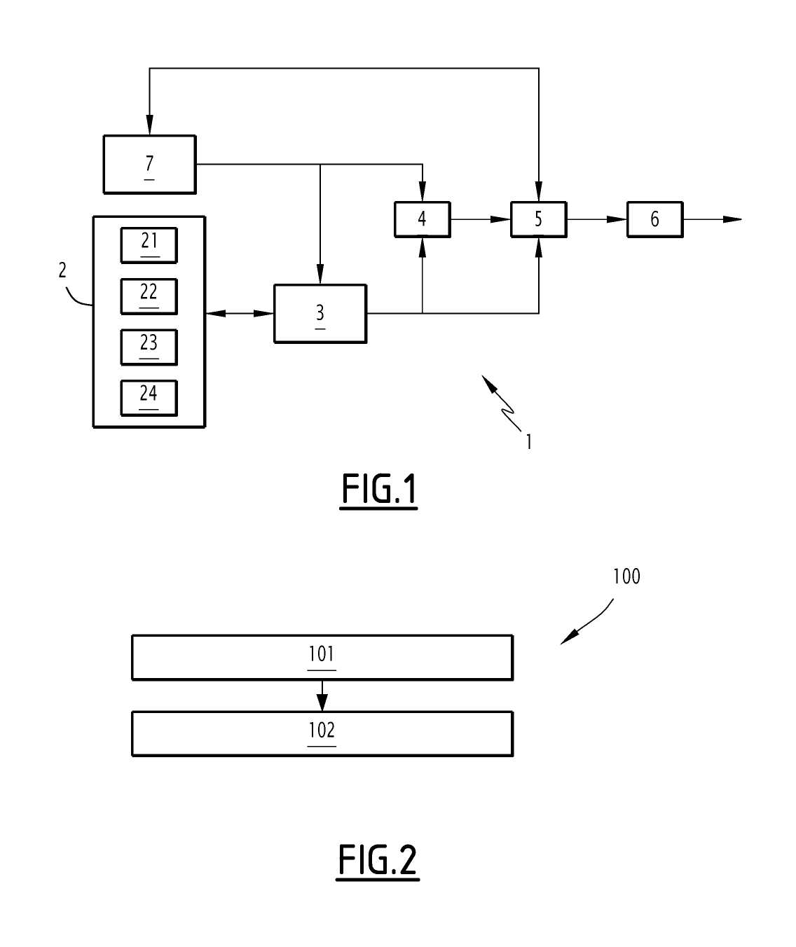

FIG. 1 shows a secure route processing system 1 for an aircraft, such as an airplane, a drone, a helicopter, etc.

This system 1 serves to produce or receive a secure route (flight plan or itinerary), make sure that the processed route is operationally coherent and that it is secure, and in case of potential risks such as, in the case of a drone, in case of excursion outside an anticipated zone, to notify the pilot or operator early enough that he can attempt an automatic or manual recovery maneuver. If there is no reaction, in the considered embodiment, the system is capable of optionally triggering an automatic emergency maneuver or even, if necessary, causing the controlled fall of the aircraft in order to prevent the feared event. Furthermore, the system 1 contributes to guaranteeing coherence with the alerts escalated by the on-board monitoring systems.

In the considered embodiment, the processing system 1 comprises a data collection unit 2, a conflict detection unit 3, a route solver unit 4, a man-machine interface MMI unit 5, a communication unit 6 and a flight plan publication unit 7. In some embodiments, each of the units 2-7 may be implemented as one or more instructions stored on a processor-readable or computer-readable medium to be executed by one or more processors. In other embodiments, each of the units 2-7 may be implemented via a corresponding dedicated hardware device including at least one processor-readable or computer-readable medium and at least one processor configured to implement the functions of the corresponding unit 2-7.

The data collection unit 2 is capable of collecting all of the data identifying potential threats that may lead to collision with the aircraft (terrain, obstacles, traffic, weather, etc.) as well as other relevant elements for the mission (flyover zones) or for the computation (MEA).

In the case considered here, it comprises collection subunits associated with different types of threats: a terrain and obstacle data collection subunit 21, a traffic data collection subunit 22, a weather data collection subunit 23 and a restriction data collection subunit 24.

The terrain and obstacle data collection subunit 21 thus collects, for example based on requests that it sends beforehand, MEA (Minimum En-route Altitude, defining the minimum altitudes to be respected by an aircraft) data, digital terrain elevation data in the form of 3D grids with a more or less fine resolution, data defining periodic and linear obstacles as well as their associated characteristics (location, elevation, obstacle type, etc.).

This subunit 21 is for example part of a database server or an integrated monitoring system of the TAWS type or the like.

The traffic data collection subunit 22 is capable of collecting and processing, in particular for format uniformization purposes, for example in polygon form, data relative to the traffic for example coming from collaborative traffic of the ADS-B data type (Automatic Dependent Surveillance-Broadcast) and/or AIS (Automatic Identification System) data for maritime traffic, and/or a ground station such as TIS-B data available in the United States, for example.

The weather data collection subunit 23 collects weather data from the various weather services necessary to have worldwide weather coverage and processes it, in particular for format uniformization purposes, here again for example in polygon form. This subunit 23 may for example be implemented by a device of the “Weather uplink” type.

The restriction data collection subunit 24 collects flight restriction data from different services of the E-NOTAM type, a list of restricted access zones updated dynamically. This subunit 24 may for example be implemented by a device of the ENOTAM (Electronic NOtice To Air Men) or D-NOTAM (Digital NOtice To Air Men) type.

It will be noted that other types of data identifying potential threats may be collected by the data collection unit 2, for example data from on-board sensors supplying azimuth, distance, size, detected obstruction uncertainty characteristics, this function for example being performed by a device of the “Proximity Warning System” type as described by patent U.S. Pat. No. 8,249,762.

The data collection unit 2 delivers, to the conflict detection unit 3, all of the data identifying the characteristics (position, size, timestamp if applicable, etc.) threats of different types, optionally in a uniform format.

The conflict detection unit 3, spontaneously or after requests are sent to the collection unit 2, receives the data relative to the potential threats delivered by the collection unit 2.

The conflict detection unit 3 is suitable for:

computing, based on the provisional route delivered by the flight plan publication unit 7 and potential threat data delivered by the collection unit 2, the risks of collisions between the aircraft and the threats along the provisional route of the aircraft, and the status of the arrival runway (different methods with detailed analysis exist) or more simplistically by superimposing the anticipated route and the threat at the anticipated passage time: if there is superposition, there is a conflict risk),

segmenting the provisional route into segments, extracting the different at-risk segments and the collision risks computed in these at-risk segments therefrom (each collision risk is thus associated with a location of the collision risk along the route, the location being able to be defined by the geographical coordinates of the segment itself or a subsegment on the segment or a point of the segment), and the lists of “risk-free”, “to be monitored” and “at-risk” zones in the form of polygons, for example,

determining, for each of these points, where there is a collision risk, the avoidance endpoint, and

delivering this information to the route solver unit 4 and to the man-machine interface unit 5.

The conflict detection unit 3 is for example implemented by a device of the “Trajectory Checker” type.

In reference to FIG. 2, the conflict detection unit 3 is capable of carrying out in particular the set 100 of steps described below.

In one embodiment, the conflict detection unit 3 comprises a computer and at least one memory (not shown) storing software instructions, which, when executed on the computer, carry out the set 100 of steps.

Thus, the conflict detection unit 3 is capable, in a step 101, based on the received provisional route and after having determined the location of each collision risk, of subdividing the received provisional route into N segments, with N greater than or equal to 2 and determining, in a step 102, for each collision risk associated with a location along the route, an endpoint for deciding to trigger an evasive maneuver and/or an endpoint for triggering an evasive maneuver.

According to the described technology, the rule applied (for example comprising the application of a vertical profile) to calculate the decision endpoint and/or the avoidance endpoint differs depending on the segments of the route. It is for example increasingly simplified (in that it requires fewer and fewer computing resources) while remaining conservative as one moves away from the current position of the aircraft.

In the particular case computed here, a separate vertical profile is defined per segment. In embodiments, the vertical profile includes at least a first section to be arranged along the provisional route. In embodiments, it further includes another section, after the first section over time, which must be positioned above (i.e., higher in altitude than) the considered collision location or level with the latter.

The segment lengths may be dynamically variable and configurable, different from one another or equal. For example, the length of one or each of several segment(s) depends on the time separating it from the current or considered position of the aircraft and the estimated speed of the aircraft over the segment, in order to guarantee the coherence with the on-board surveillance and display systems and to concentrate the precision and computing power on the elements of interest to the crew.

The maximum size, the number of segments as well as the vertical profile applied to each segment are configurable.

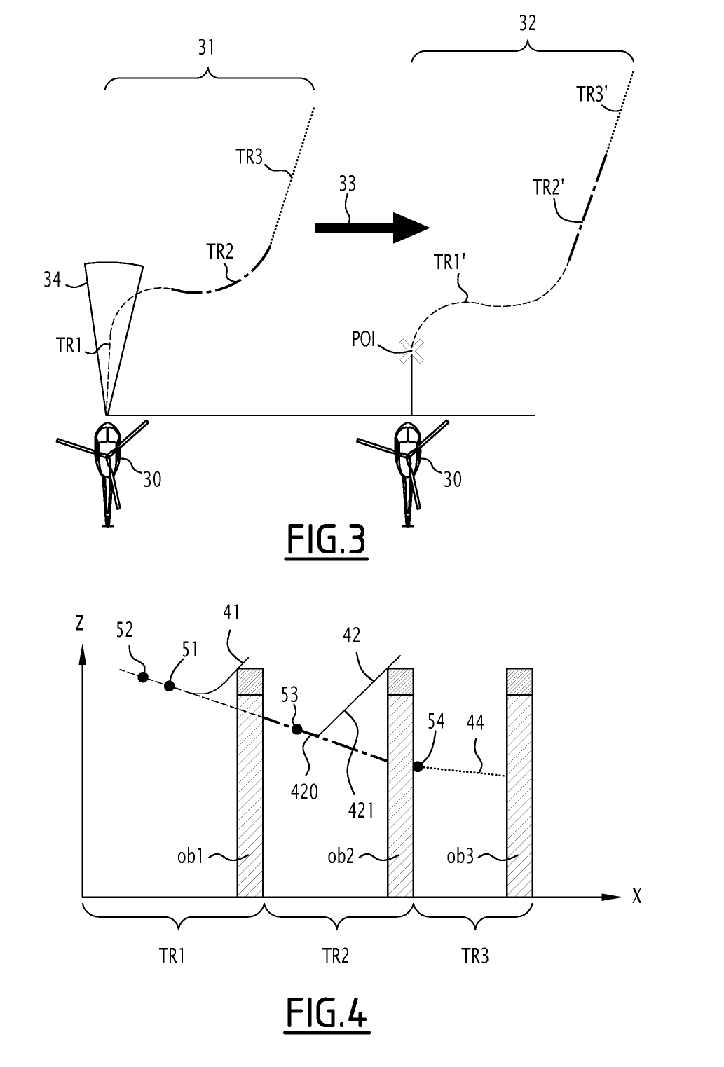

In one embodiment illustrated in FIGS. 3 and 4, in the case of an aircraft 30 of the helicopter type, the provisional route is thus subdivided into 3 segments.

The helicopter 30 is equipped with a TAWS system. As a reminder, the operating principle of a TAWS system (cf. for example FR 2,864,270) is the combination of measured flight parameters (position, speed) with a digital terrain model to extrapolate the current flight parameters and deduce a theoretical trajectory therefrom and calculate the potential intersections of the extrapolated trajectory of the aircraft with the terrain or obstacles on the ground. Alerts are generated for the crew in case of abnormal proximity. The theoretical trajectory is potentially different from the flight plan, since the TAWS is not coupled to the navigation (to avoid common failure modes). The extrapolation field, and therefore “vision” of the TAWS, is usually several minutes of flight, between 1 to 5 minutes for example, 2 minutes in the considered case.

The length of the first segment of the provisional route is configured as a function of the length of the maximum viewing field of the TAWS; it is configured, in the considered example, so as to cover at most the same length as the maximum viewing field of the TAWS, extended, in embodiments, by an anticipation delay making it possible to prepare the pilot for the risk of occurrence of a TAWS alert. Indeed, when this alert occurs, the pilot must react immediately and correct the normalized trajectory (“pull-up” action where the pilot pulls the control stick to raise the vehicle). It therefore appears useful to anticipate this risk finely while allowing him to perform the correction of his choice (lateral maneuver, for example). This first segment begins in the commonly considered position of the helicopter 30 and ends at minimum at the endpoint of the viewing field of the TAWS (equal to T1×V1, where T1=2 minutes (+1 minute of anticipation for example) and V1 is the speed extrapolated on the TAWS viewing field), or of course to the destination point if it is located in front).

In the first segment, the closest to the helicopter on the considered provisional route, the conflict detection unit 3 uses, to determine the decision endpoint and/or the avoidance endpoint relative to the location of the collision risk, a vertical profile of the evasive maneuver type of a surveillance and alert system on board the helicopter 30, here TAWS, is used, with the aim of providing continuity between the system 1 and the TAWS in terms of alert.

The second segment, in the considered case, begins at the end of the first segment and ends at the average display endpoint used by the operator of the helicopter on his piloting control system. Average display endpoint refers to the scale most commonly used by the operator of the aircraft to perform strategic monitoring of this mission type (40 Nm, for example) via the mission or navigation MMI. This use makes it possible to present the potential at-risk threats and the associated avoidance points by using limited hardware resources while guaranteeing acceptable coherence between the information shown to the operator from various sources.

In this second segment, the conflict detection unit 3 uses, to determine the decision endpoint and/or the avoidance endpoint relative to the location of a collision risk, a vertical profile of the simplified TAWS evasive maneuver type, for example made up of two line segments. The first segment corresponds to the gradient of the flight profile on the concerned route piece. The second segment corresponds to the maximum climb gradient of the helicopter in the location in question (gradient depending on the altitude and temperature, for example).

The third segment, in the considered case, begins at the end of the second segment and ends at the end of the provisional route.

In this third segment, the conflict detection unit 3 uses, to determine the decision endpoint and/or the avoidance endpoint relative to the location of a collision risk, a profile corresponding to the gradient of the provisional route in the considered collision risk location.

Thus on the section 31 in the left part of FIG. 3, the first segment TR1 (shown in dashes), the second segment TR2 (shown in alternating long and short dashes) and the third segment (shown in dotted lines) of the provisional route remaining to be traveled by the helicopter 30 from its current position are shown in top view (i.e., in two dimensions: longitude and latitude). The field of view 34 of the TAWS system is also shown.

The section 32 on the right in FIG. 3 illustrates the processing done in case of a scrolling operation by an operator from a display screen and symbolized by the arrow 33, to bring the considered point of interest, previously the current position point of the helicopter 30, to a provisional passage point POI on the route. In this case, in the determination of a decision endpoint and/or avoidance endpoint, the conflict detection unit 3 causes the first segment TR1′ to begin from the point of interest POI and no longer from the current position of the helicopter 30. This makes it possible to move the computing effort and analysis fineness to the location where the pilot wishes to focus.

In FIG. 4, the segments TR1, TR2, TR3 are shown in side view, in the two altitude dimensions on the y-axis, and for example longitude on the x-axis. Additionally, the determination of a decision endpoint and/or avoidance endpoint by the conflict detection unit 3 is illustrated in light of an obstacle identified as a collision risk ob1 in the segment TR1, respectively ob2 in the segment TR2, and ob3 in the segment TR3.

The surface of each of said obstacles in the considered vertical plane is crosshatched, a vertical margin having been added in tighter crosshatching.

The vertical profile 41 of the TAWS evasive maneuver type is applied by the conflict detection unit 3 such that the upstream part of the profile 41 follows the provisional route (in dashes) and such that the downstream part of the profile 41 passes above the obstacle ob1. Thus, the latest point on the provisional route for implementing an evasive maneuver along the vertical profile is determined: the point 51. An additional margin is optionally applied, and the unit 3 determines the point 52 of the provisional route as a decision endpoint and/or avoidance endpoint for the obstacle ob1.

Similarly, the vertical profile 42, comprising a first segment 420 and a second segment 421 (the second segment corresponding to the maximum climb gradient of the aircraft in the relevant location from the first segment) is applied by the conflict detection unit 3 such that the first segment 420 follows the provisional route (alternating long and short dashes) and such that the second segment 421 passes above the obstacle ob2. Thus, the unit 3 determines the point 53 of the provisional route as a decision endpoint and/or avoidance endpoint for the obstacle ob2.

The conflict detection unit 3 uses, to determine the decision endpoint and/or the avoidance endpoint relative to the location of a collision risk on the segment TR3, a profile 44 along the gradient of the provisional route in the considered collision risk location and determines the point 54 of the provisional route as a decision endpoint and/or avoidance endpoint for the obstacle ob3. This point is placed by rising from the position of the collision risk and along the provisional route, by an inclusive time value corresponding to the time needed for the pilot to make a decision. This time value may for example depend on, for example be equal to, the cumulative time of the first two segments.

This information is next sent to the man-machine interface unit to present the situation to the crew and/or to the route solver unit, which will see to the calculation of a workaround solution.

In one embodiment, the processing system 1 comprises a decision-making unit optionally on board (not shown in the figures) capable of making decisions based on avoidance endpoints, at-risk segments and segments to be monitored.

In the case of coupling of the described technology with an automatic pilot device (“Avionic Device for trajectory” solution) and if there is no reaction, and before the evasive maneuver endpoint is reached, the optional on-board decision-making unit triggers an evasive maneuver request depending on the type of aircraft, of the mission type and of the collision threat type. This maneuver will for example be sent to a device of the automatic pilot or FMS/Mission manager type.

For a fixed-wing aircraft (UAV or not), the evasive maneuver thus triggered may for example be of the auto pull-up type (vertical resource) with or without lateral evasive maneuver.

For a rotary aircraft (UAV or not), the triggered evasive maneuver may be of the auto pull-up type (vertical resource) with or without lateral evasive maneuver or it may consist of a transition to hovering if the situation (stationary threat, performance of the carrier, etc.) allows it.

For a UAV, depending on the type of threat (entry into a prohibited zone, for example), the maneuver may consist of automatic landing in a clear area or a holding pattern.

In all scenarios, the maneuver may either be standardized, or proposed by a device of the route solver/FMS type and variable depending on the mission, the threat type, the equipment and its status (performance, failing systems).

The route solver unit 4 is suitable for receiving the current provisional route delivered by the route publication unit 7, the list of at-risk segments and other information relative to the collisions delivered by the conflict detection unit 3 and proposing a new provisional route making it possible to avoid the at-risk segments, which it delivers to the man-machine interface unit 5 for validation.

This unit 4 may for example be implemented by a device of the Flight Management System or Mission Management System type.

The man-machine interface unit 5 is capable of:

displaying, for the operator (pilot or drone operator), the current provisional route delivered by the route publication unit 7, as well as all the information relative to the collision risks and delivered by the conflict detection unit 3;

displaying the new provisional routes delivered by the route solver unit 4 and following a new validation entry done by the MMI unit 5 by the pilot of a new route (proposed by the route solver unit or defined by the pilot), delivering the new validated route to the route publication unit 7;

upon receiving an alert request from the conflict detection unit 3, alerting the operator.

This man-machine interface unit 5 is for example implemented in a device of the IHS (Interface with Human management System) or CDS (Cockpit Display System) type.

The communication unit 6 is suitable for seeing to the exchange of data (in particular the provisional routes validated at the man-machine interface unit 5) between the devices located in the certified avionics part of the aircraft and those located on the ground or in the noncertified (Open World) part on board the aircraft.

This unit is for example implemented by a device of the “Secured Communication Server” type.

The route publication unit 7 is suitable for obtaining the current provisional route that has been computed for the aircraft, i.e., the 4D flight plan or trajectory (in particular the coordinates, altitude and passage time associated with the various points of the route), the route having been computed based on several criteria, in particular the memorization of the fuel consumption, and delivering it to the data collection unit 2, the conflict detection unit 3, the route solver unit 4 and the MMI unit 5.

This unit 7 may for example be an automatic pilot device. In a mode not coupled to the FMS, it will publish the trajectory based on the extrapolation of the inputs supplied by the pilot. This device may also be part of a device of the FMS type. In a mode coupled to the Automatic Pilot, it will supply the joining trajectory between the current position of the vehicle and the flight plan. The published provisional route is built a priori and therefore independent of any dynamic constraint (weather, traffic).

When the unit 7 is also responsible for building the route, it also serves to manage access to the navigation database of the Arinc 424 type, manage the man-machine interface allowing personnel to create/modify a route and manage the switching between routes.

The unit 7 further receives the modified routes after validation via the MMI unit 5.

This unit 7 may be part of a mission preparation unit or an on-board device of the MMS (Mission Management System) or FMS (Flight Management System) type.

It will further be noted that the functions or units of a system like the secure route processing system 1 can be distributed in various ways.

In one embodiment, the system is arranged completely on the ground, within a same piece of equipment. The device produces a validated flight plan that is re-updated with respect to the evolution of the threats. This flight plan is next sent to the aircraft (drone type, for example) via the communication unit. The advantage of this solution is to allow periodic and secure re-updating of a flight plan/trajectory without human intervention on board the aircraft (or in any case, intervention limited to flight plan loading and activation actions) while benefiting from the computing power of a device located on the ground.

In one embodiment of a system of the EFB type, part of the system 1 comprising the route publication unit and the communication unit, which is responsible for communicating the flight plan and the associated predictions, in some embodiments is advantageously located in the certified avionics, for example in an existing device of the FMS type. Another part, comprising the other units of the system, is offloaded on a second piece of equipment and verifies the trajectory and presentation of the detected conflicts. This second piece of equipment is located on the ground or in another noncertified part of the avionics of the aircraft (ESB or Open World, for example). Optionally, the offloaded part may make it possible to modify the flight plan manually or via a route solver and to send the changes through the communication unit.

The advantage of this solution is to allow securing and updating of the flight plan on existing aircraft without upsetting the avionics architecture and while benefiting from the processing power of EFB/Open World equipment. To implement it on existing aircraft, it requires modifying the existing avionics device to allow it to send and receive a flight plan and to communicate these data to a device of the EFB/Open World type. In some embodiments, this link is advantageously direct. It is possible to consider passing the data through a ground system. It is also possible to establish a good backup means in case of major failure of the avionics with respect to the management of the flight plan.

In one embodiment, part of the system comprising the route publication unit, the MMI, the route solver unit, is offloaded into the noncertified avionics part of the aircraft or to the ground. It is responsible for proposing a flight plan to be validated by the certified avionics part. Once the flight plan is validated, it is capable of being transferred directly to a certified on-board device of the FMS or Mission Management System type, for example. This flight plan is sent through the communication unit. The other part of the system is responsible for verifying that the trajectory is safe with respect to various threats. If this is not the case, it provides the threat level and the list of zones to be avoided to the offloaded part via the communication unit. If a conflict is detected, the operator has complete freedom to modify the trajectory via the offloaded part or by adopting or adapting the solution proposed by the route solver. Once the latter is validated, it is returned for reverification in the avionics part. It may also be transferred directly to a certified on-board device of the FMS or Mission Management System type, for example. This flight plan is sent through the communication unit. In this case, after verification, the avionics part of the device may provide the on-board device of the FMS or Mission Management System with a signature element making it possible to identify the validated trajectory. This will allow the FMS or Mission Management System to activate only a valid trajectory. The advantage of this solution lies in allowing end-to-end securing of the flight plan. This is entirely produced in a noncertified environment, which makes it possible to have much more latitude regarding the proposed MMIs and in terms of computing power for the route solver unit in particular. The avionics part is responsible for verifying the flight plan. It thus guarantees that the received data are safe from the perspective of the flight (which for example makes it possible to protect against a coherent malicious corruption of the data). This also allows significant reactivity by the crew, since it is informed periodically and directly of the evolution of a threat.

In one embodiment of the Avionics for flight plan system 1, all of the units of the system are implemented in an avionics device of the FMS or MMS type or on dedicated equipment receiving the flight plan data from said FMS/MMS. Optionally, the collection unit 2 can be offloaded to one or several communication and/or surveillance devices located in the avionics. The advantage of this solution lies in allowing end-to-end securing of the flight plan, irrespective of its origin (prepared on the ground, in flight in an FMS-type device). The avionics part is responsible for verifying the flight plan. It thus guarantees that the received data are safe from the perspective of the flight (which for example makes it possible to protect against a coherent malicious corruption of the data). This also allows significant reactivity by the crew, since it is informed periodically and directly of the evolution of a threat.

In one embodiment of the system 1 of the Avionics for trajectory type, all of the units are implemented either in an avionics device of the surveillance type, such as a TAWS or its integrated ISS (Integrated Surveillance System) version, or on dedicated equipment receiving the trajectory data. Optionally, the collection unit 2 can be offloaded to one or several communication and/or surveillance devices located in the avionics. The advantage of this solution lies in allowing tactical securing of the trajectory providing visibility to the crew over a longer period than existing devices of the “safety net” type, which, in case of alert, ask to perform an immediate maneuver generating a high stress level for the crew. For drones in particular, it may lead to a maneuver triggered automatically.

While there have been shown and described and pointed out the fundamental novel features of the invention as applied to certain inventive embodiments, it will be understood that the foregoing is considered as illustrative only of the principles of the invention and not intended to be exhaustive or to limit the invention to the precise forms disclosed. Modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplate. All such modifications and variations are within the scope of the invention as determined by the appended claims when interpreted in accordance with the breadth to which they are entitled.

1-10. (canceled)

11. A method for determining endpoint(s) for deciding to trigger an evasive maneuver by an aircraft, the method implemented by a programmable computer and comprising:
obtaining an anticipated route of the aircraft and a set of locations on the route presenting a collision risk for the aircraft;
determining, for each location of the set, an endpoint for deciding to trigger an evasive maneuver associated with the location, by applying a rule for determining an endpoint associated with the location; and
segmenting the route into a set of N route segments, with N≥2,
wherein the rule for determining the endpoint associated with the location of the set is a function of the route segment in which the location associated with the set is located.

12. The method according to claim 11, wherein the rule for determining the endpoint associated with the location of the set that is located in a first segment of the set of segments comprises applying, relative to the location, a first predefined vertical profile, and wherein the rule for determining the endpoint associated with the location of the set that is located in a second segment of the set of segments and different from the first segment comprises applying, relative to the location of the set, of a second predefined vertical profile different from the first vertical profile.

13. The method according to claim 11, wherein a first segment of the set of segments extends from the current position of the aircraft and up to at least the furthest point from the aircraft on the anticipated route that is located in the detection field of an on-board monitoring device during flight proposing anti-collision maneuvers.

14. The method according to claim 12, wherein the first vertical profile corresponds to a vertical profile of the Terrain Awareness and Warning System (TAWS) evasive maneuver type.

15. The method according to claim 14, wherein the second segment extends from the end of the first segment distant from the aircraft, and the second vertical profile comprises a first line segment along the route and a second line segment corresponding to a gradient greater than that of the first line segment.

16. The method according to claim 15, wherein a third segment of the set of segments extends from the end of the second segment distant from the first segment, and the rule for determining the endpoint associated with the location of the set that is located in the third segment comprises applying, relative to the point of the set, of a third profile corresponding to a single line segment with a gradient calculated as a function of the gradient of the anticipated route on the third segment.

17. A computer program for including software instructions which, when executed by a computer, carry out the method according to claim 11.

18. A device for determining endpoint(s) for deciding to trigger an evasive maneuver by an aircraft, comprising:
a first unit suitable for obtaining an anticipated route of the aircraft and a set of location(s) on the route presenting a collision risk for the aircraft; and
a second unit suitable for determining, for each location of the set, an endpoint for deciding to trigger an evasive maneuver associated with the location, by applying a rule,
wherein the device configured to segment the route into a set of N route segments, with N≥2, and
wherein the rule for determining an endpoint associated with a location of the set is a function of the route segment in which the location associated with the set is located.

19. The device for determining decision endpoint(s) according to claim 18, wherein the rule for determining the endpoint associated with the location of the set that is located in a first segment of the set of segments comprises applying, relative to the location, a first predefined vertical profile, and the rule for determining the endpoint associated with the location of the set that is located in a second segment of the set of segments and different from the first segment comprises applying, relative to the location of the set, a second predefined vertical profile different from the first vertical profile.

20. The device for determining decision endpoint(s) according to claim 18, wherein a first segment of the set of segments extends from the current position of the aircraft and up to at least the furthest point from the aircraft on the anticipated route that is located in the detection field of an on-board monitoring device during flight proposing anti-collision maneuvers.
